(19) United States
(12) Patent Application Publication
(10) Pub. No.: US 2004/0218537 A1
(43) Pub. Date: Nov. 4, 2004

(54) Exchanger capable of detecting network system

(76) Inventor: Ray Lee, Hsin Chuang City (TW)

Correspondence Address: Ray Lee, P.O.Box 4-67, Hsin Chuang, Taipei, 242, TW

(21) Appl. No.: 10/429,529

(22) Filed: May 2, 2003

(51) Int. Cl. H04L 12/26

(52) U.S. Cl. 370/241

(57) ABSTRACT

An exchanger device includes an exchanger integrated circuit coupled to a processor device, one or more couplers for coupling to network systems or end users, a display for information displaying purposes, and a fictitious cable detecting circuit, and a button coupled to the processor device for actuating the fictitious cable detecting circuit to detect the communication between the exchanger device and the network systems. The exchanger device may be used to detect and display the status or situations of the network system, for allowing users to easily overcome the problems.

### BACKGROUND OF THE INVENTION

1. Field of the Invention

The present invention relates to an exchanger facility, and more particularly to an exchanger facility capable of detecting whether the network system is in good order or is working or not.

2. Description of the Prior Art

Typical exchanger facilities may comprise a number of ports or couplers for coupling to a number of end users simultaneously, and are provided for allowing the end users to communicate with each other, and/or to communicate with various network systems, such as ethernet network systems, local area network (LAN) systems, wireless local area network (WLAN) systems, etc.

The end users that are simultaneously coupled to the typical exchanger facility may communicate with each other and may share the information from the network systems.

However, when the communication of the end users with the network systems is interrupted, shorted, or out of order, a number of additional man powers, and detecting facilities, and programs, and the like are required to be provided to detect what kind of problems have occurred to the network systems, and which location or position has become wrong, before the interruptions or shortages or obstructions or the like may be overcome by workers.

In addition, it takes a lot of time to detect the location or position that has become wrong, and to detect the problems of the network systems.

The present invention has arisen to mitigate and/or obviate the afore-described disadvantages of the conventional exchanger facilities.

### SUMMARY OF THE INVENTION

The primary objective of the present invention is to provide an exchanger facility capable of detecting whether the network system is in good order or is working or not.

The other objective of the present invention is to provide an exchanger facility capable of displaying the detected status or situations of the network system in displays.

In accordance with one aspect of the invention, there is provided an exchanger facility comprising an exchanger device including a processor device, an exchanger integrated circuit coupled to the processor device, at least one coupler for coupling to network systems, a display coupled to the processor device for information displaying purposes, and a fictitious cable detecting circuit for detecting a communication between the exchanger device and the network systems. The exchanger device is capable of detecting whether the network system is in good order or is working or not, and capable of displaying the detected status or situations of the network system in displays, for allowing the workers to easily and quickly overcome the interruptions or shortages or obstructions of the network systems.

The exchanger device includes a button coupled to the processor device for actuating the fictitious cable detecting circuit to detect the communication between the exchanger device and the network systems.

The exchanger device includes at least one memory coupled to the processor device, to store information detected by the fictitious cable detecting circuit. The exchanger device includes at least one second coupler for coupling to end users. The exchanger device includes at least one memory coupled to the processor device, to store information of the end users.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial plan schematic view of an exchanger facility in accordance with the present invention;

FIG. 2 is a block diagram of an exchanger device of the exchanger facility; and

FIG. 3 is a block diagram illustrating the operation of the exchanger facility.

### DETAILED DESCRIPTION OF THE PREFERRED EMBODIMENT

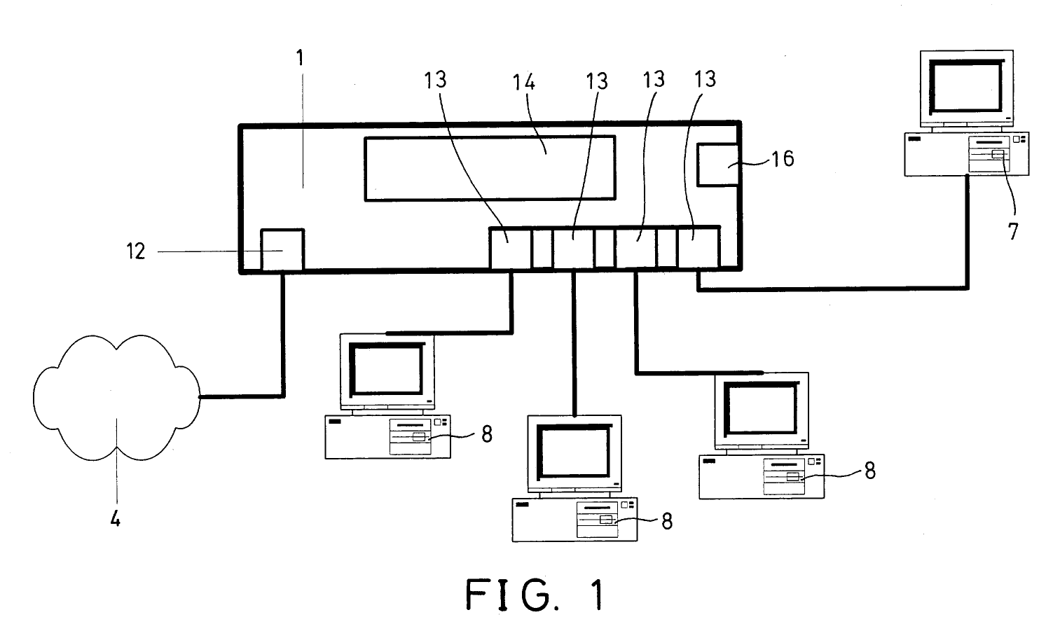

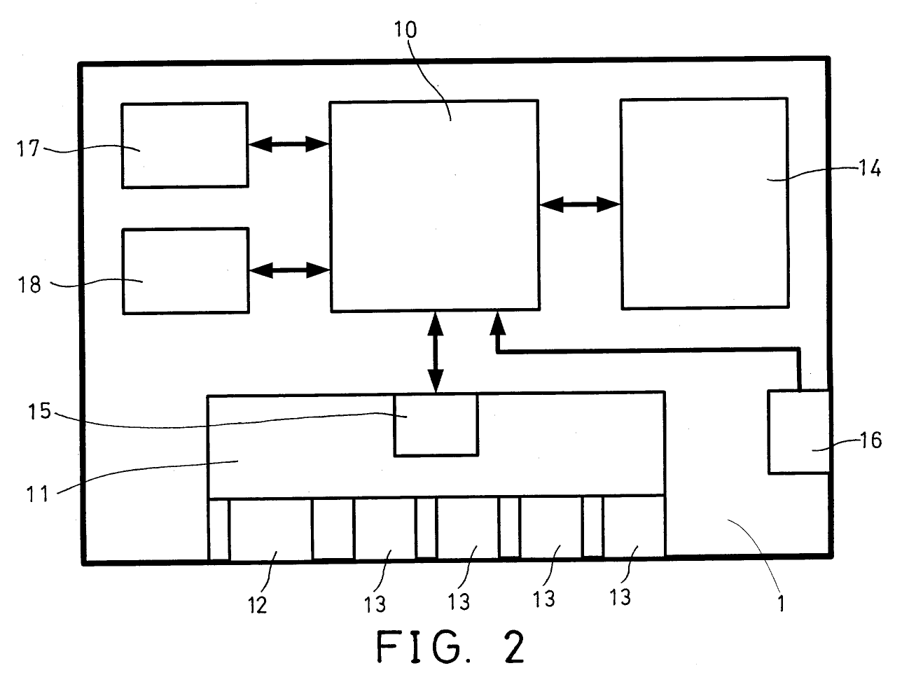

Referring to the drawings, and initially to FIGS. 1 and 2, an exchanger facility in accordance with the present invention comprises an exchanger device 1 including a microprocessor or central processor unit or processor device 10, for receiving and processing various information or data or the like, and including an exchanger chip or integrated circuit 11 coupled to the processor device 10 for telecommunication purposes or for receiving and exchanging various information or data or the like.

The exchanger device 1 includes one or more ports or couplers 12 for coupling to various network systems 4, such as ethernet network systems, local area network (LAN) systems, wireless local area network (WLAN) systems, etc.; and further includes one or more ports or couplers 13 for coupling to one or more end users 7, 8 simultaneously, and thus for allowing the end users 7, 8 to communicate with each other, and/or to communicate with or to share the various network systems 4.

A display 14, such as a liquid crystal display (LCD) or the like, is provided and coupled to the processor device 10, to display various data or information or images.

The exchanger integrated circuit 11 includes a fictitious cable detecting circuit 15 to emit one or more detecting signals to all of the wires or cables or communication systems, and to receive the reflected or returned signals, in order to detect or to judge or to determine whether the network system is interrupted, shorted, or out of order, or not, and/or to calculate the location or position or distance of the wires or cables or communication systems that has gone wrong.

The detected problems, locations or positions, interruptions, shortages or obstructions or the like by the fictitious cable detecting circuit 15 of the exchanger integrated circuit 11 may then be sent to the processor device 10, and/or may then be shown in the display 14. The workers or the users may then easily overcome or fix or recover the detected problems, locations or positions, interruptions, shortages or obstructions or the like.

A button 16 may further be provided and coupled to the processor device 10, in order to actuate the fictitious cable detecting circuit 15 of the exchanger integrated circuit 11 to start to detect whether the network system is interrupted, shorted, or out of order, or not, and/or to calculate the location or position or distance of the wires or cables or communication systems that has gone wrong.

One or more memories 17, 18, such as one or more flash memories 17 and one or more synchronous dynamic access memories 18 may further be provided and coupled to the processor device 10, for storing the identifications, the data or information of the end users 7, 8, for example, and/or for storing the data or information from the fictitious cable detecting circuit 15.

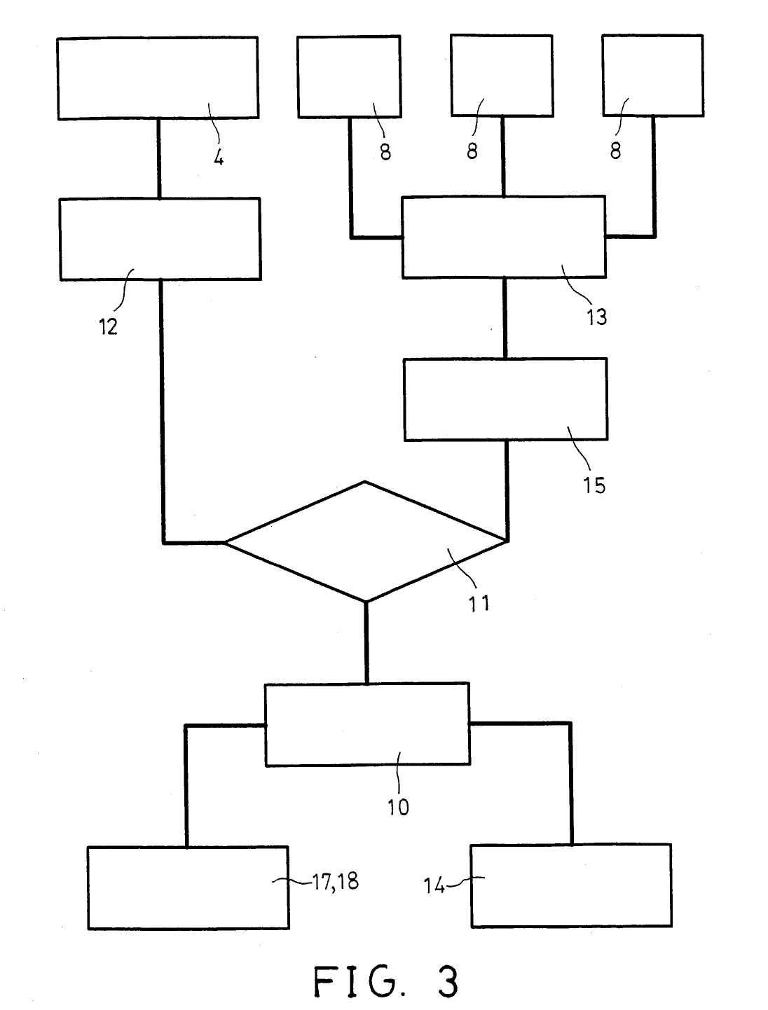

In operation, as shown in FIGS. 1-3, the end users 7, 8 may be coupled or connected to various network systems 4 via the couplers 12. The exchanger integrated circuit 11 may then receive and detect the package or information where from, and/or the destinations thereof, and may then send the information to the processor device 10, and/or to the other end users 7, 8.

When either of the end users 7, 8 is interrupted, shorted, or out of order, or may not suitably couple to the network systems 4, the button 16 may be depressed to actuate the fictitious cable detecting circuit 15 to emit one or more detecting signals to all of the wires or cables or communication systems, and to receive the reflected or returned signals, and thus to detect or to judge or to determine whether the network system is interrupted, shorted, or out of order, or not, and/or to calculate the location or position or distance of the wires or cables or communication systems that has gone wrong.

The detected problems, locations or positions, interruptions, shortages or obstructions or the like by the fictitious cable detecting circuit 15 may then be sent to the processor device 10, and to be processed by the processor device 10, and/or sent to and displayed in the display 14, and/or sent to and stored in such as the synchronous dynamic access memories 18.

The workers or the end users 7, 8 may then easily overcome or fix or recover the detected problems, locations or positions, interruptions, shortages or obstructions or the like, according to the information stored in such as the synchronous dynamic access memories 18, and/or displayed in the display 14, without additional man powers, and detecting facilities, and programs, and the like.

Accordingly, the exchanger facility in accordance with the present invention is capable of detecting whether the network system is in good order or is working or not, and capable of displaying the detected status or situations of the network system in displays, for allowing the workers to easily and quickly overcome the interruptions or shortages or obstructions of the network systems.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An exchanger facility comprising an exchanger device including a processor device, an exchanger integrated circuit coupled to said processor device, at least one coupler for coupling to network systems, a display coupled to said processor device for information displaying purposes, and a fictitious cable detecting circuit for detecting a communication between said exchanger device and the network systems.

2. The exchanger facility as claimed in claim 1, wherein said exchanger device includes a button coupled to said processor device for actuating said fictitious cable detecting circuit to detect the communication between said exchanger device and the network systems.

3. The exchanger facility as claimed in claim 1, wherein said exchanger device includes at least one memory coupled to said processor device, to store information detected by said fictitious cable detecting circuit.

4. The exchanger facility as claimed in claim 1, wherein said exchanger device includes at least one second coupler for coupling to end users.

5. The exchanger facility as claimed in claim 1, wherein said exchanger device includes at least one memory coupled to said processor device, to store information of the end users.
